(19) United States
(12) Patent Application Publication
(10) Pub. No.: US 2009/0059572 A1
(43) Pub. Date: Mar. 5, 2009

(54) SOLAR LAMP

(76) Inventor: Ching-Hsiang WANG, Tainan City (TW)

Correspondence Address: Ching-Hsiang WANG, P.O. BOX 90, Tainan City, 70499, TW

(21) Appl. No.: 11/845,796

(22) Filed: Aug. 28, 2007

(51) Int. Cl. F21L 4/08

(52) U.S. Cl. 362/183

(57) ABSTRACT

A solar lamp includes a supporting board for being loaded with a solar panel, a lower shell, an LED board, a light diffusion tube and a reflecting base. The lower shell is fixed under the supporting board, having a battery and a circuit board. The LED board and the reflecting base are threadably engaged the lower shell. The light diffusion tube possesses refracting grooves on its wall. The reflecting base is positioned under the light diffusion tube by means of an adjustment rod. The solar lamp, able to convert sunlight into power energy without any wiring connection, can be easily assembled in any lamp base to create a great light diffusion via the alternate refraction of the refracting grooves and reflecting surfaces of the lower shell and the reflecting base.

### BACKGROUND OF THE INVENTION

1. Field of the Invention

This invention relates to a solar lamp, particularly to one composed of a supporting board for being loaded with a solar panel, a lower shell provided with a battery and a circuit board, an LED board, a light diffusion tube formed with refracting grooves among its wall, and a reflecting base. Such a solar lamp, able to convert sunlight into power energy without any wiring connection, can be easily assembled in any lamp base to create a great light diffusion via alternate refraction of the refracting grooves of the light diffusion tube and reflecting surfaces of the lower shell and the reflecting base.

2. Description of the Prior Art

Commonly, a conventional lamp is lit up by wires connected with power supply. For example, in order to decorate a courtyard with outdoor lights to create a leisurely elegant atmosphere, a conventional connection of wires employed to supply power is totally unavoidable, not only having a complicated wiring but also consuming energy uneconomically.

### SUMMARY OF THE INVENTION

The objective of this invention is to offer a solar lamp installed in a courtyard, able to convert sunlight into power energy without any wiring connection and create a great light diffusion via alternate refraction of refracting grooves of a light diffusion tube and reflecting surfaces of a lower shell and a reflecting base.

The solar lamp is provided with a supporting board for being loaded with a solar panel, a lower shell fixed under the supporting board, an LED board screwed under the lower shell, a light diffusion tube wrapped around the LED board with refracting grooves formed among its wall, and a reflecting base positioned under the light diffusion tube with an adjustment rod.

### BRIEF DESCRIPTION OF DRAWINGS

This invention is better understood by referring to the accompanying drawings, wherein:

FIG. 1 is an exploded perspective view of a preferred embodiment of a solar lamp in the present invention;

FIG. 2 is a perspective view of the preferred embodiment of a solar lamp in the present invention;

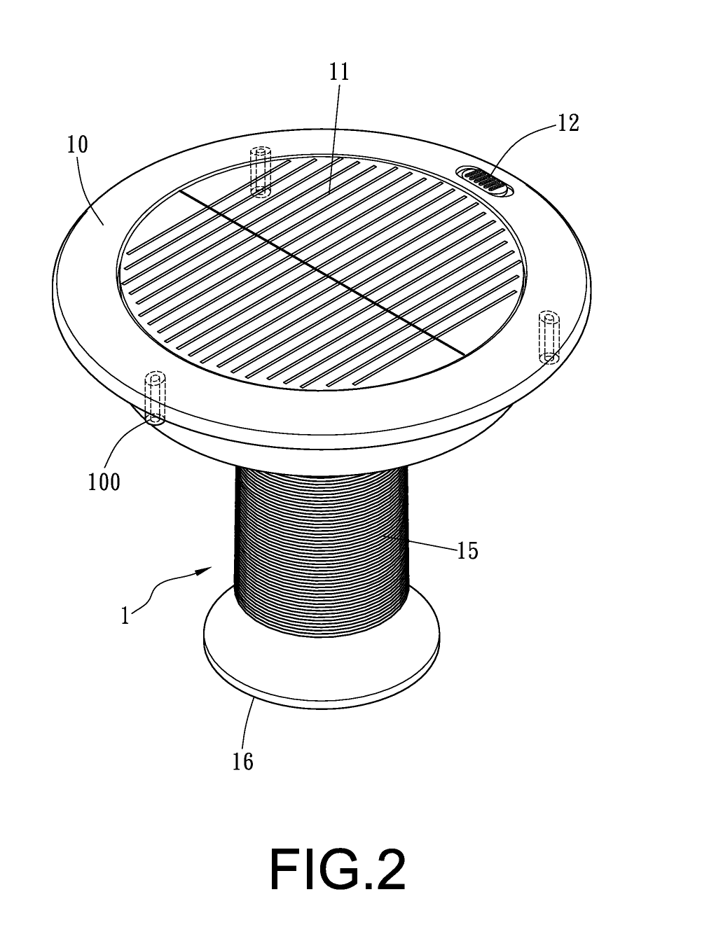

FIG. 3 is a cross-sectional view of the preferred embodiment of a solar lamp in the present invention; and

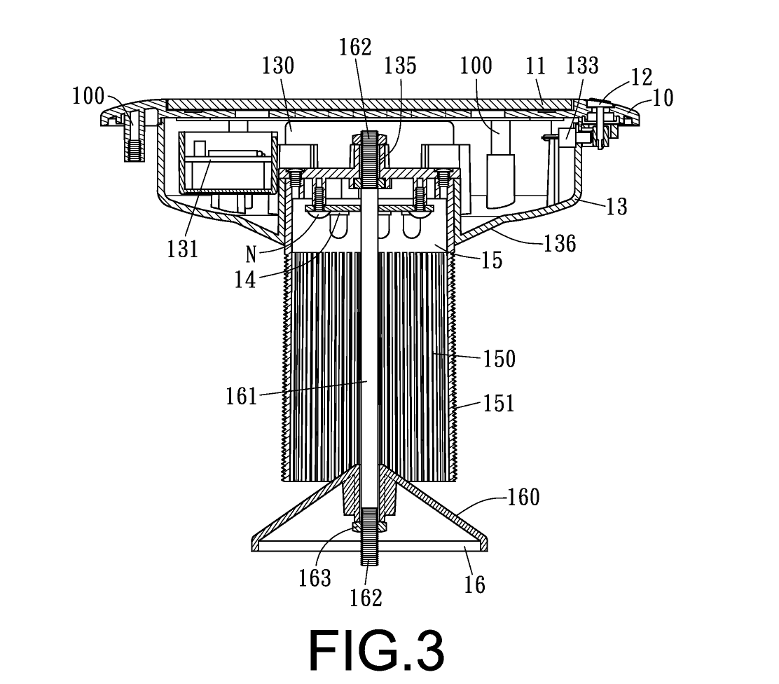

FIG. 4 is a perspective view of the preferred embodiment of a solar lamp in the present invention, showing it being installed in a lamp base.

### DETAILED DESCRIPTION OF THE PREFERRED EMBODIMENT

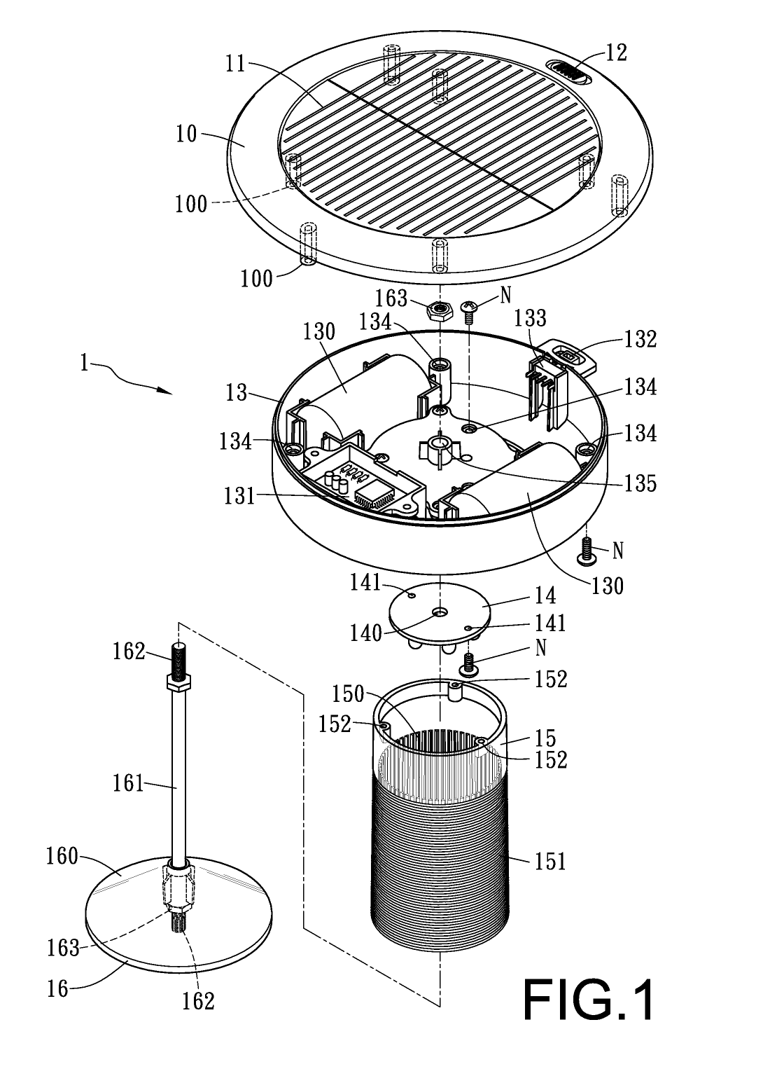

As shown in FIGS. 1˜3, a preferred embodiment of a solar lamp 1 in the present invention is mainly composed of a supporting board 10, a lower shell 13, an LED board 14, a light diffusion tube 15 and a reflecting base 16.

The supporting board 10 is to be loaded with a solar panel 11, provided with a press-button switch 12 positioned aside and plural positioning bars 100 planted at its bottom.

The lower shell 13 is installed under the supporting board 10, provided with a battery 130, a circuit board 131, a switch base 132 located at its outer wall for corresponding to the press-button switch 12, a switch 133 positioned at the inner side of the switch base 132, plural threaded holes 134, a through hole 135 formed on its center, and a reflecting surface 136 formed at its bottom surface.

The LED board 14 is fixed at the bottom of the lower shell 13, provided with a through hole 140 bored at its center and two screw holes 141 symmetrically bored near its circumference.

The light diffusion tube 15 is fitted around the LED board 14, provided with straight refracting grooves 150 formed closely spaced apart on its inner wall, spiral refracting grooves 151 formed on its outer wall, and plural threaded holes 152 formed around its upper inner circumference.

The reflecting base 16 is installed at the bottom of the light diffusion tube 15 threadably connected to the lower shell 13, provided with a conical reflecting surface 160 formed on its bottom, an adjustment rod 161 positioned upright at its center, and two threaded portions 162 formed at two ends of the adjustment rod 161 to engage with nuts 163 to adjust its height.

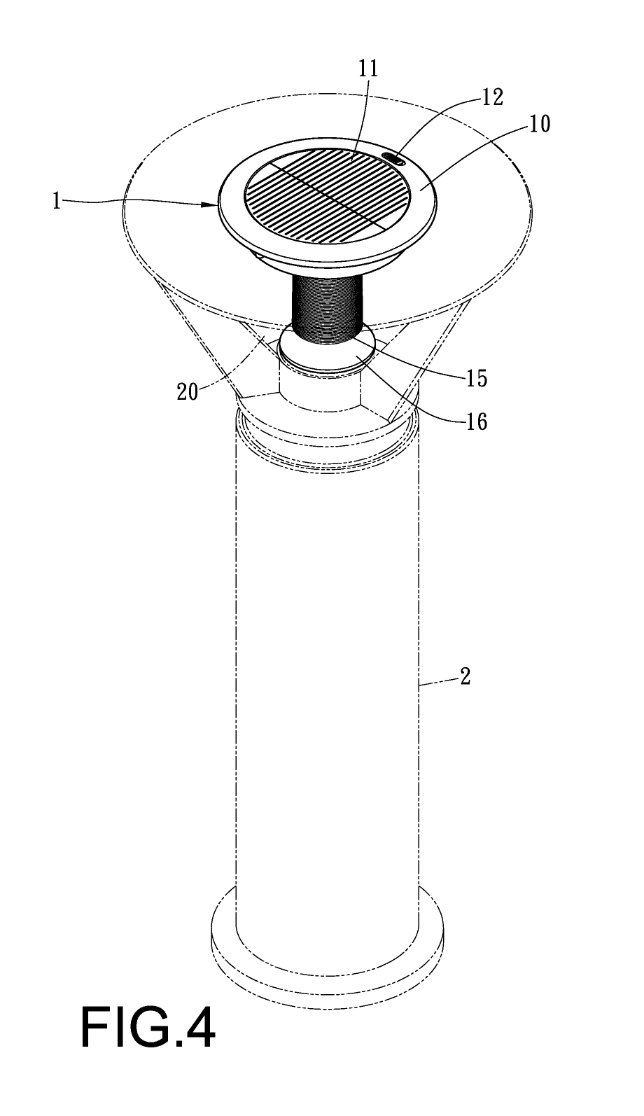

In assembling, as shown in FIGS. 1˜4, first, combine the LED board 14 and the light diffusion tube 15 with the lower shell 13 by means of screws (N). Next, the reflecting base 16 is combined with the lower shell 13 by passing the top threaded portion 162 of the adjustment rod 161 of the reflecting base 16 through the through hole 135 of the lower shell 13 with the nut 163 engaged with the top threaded portion 162. Then, keep the positioning bars 100 of the supporting board 10 aimed exactly at the threaded holes 134 of the lower shell 13 so as to enable them engaged with one another by means of the screws N. Then, the solar lamp 1 of the present invention is assembled completely, possible to be assembled with any lampshade 20 of a lamp base 2, as shown in FIG. 4.

In using, during the day time, sunlight can be converted into power energy to be stored in the battery 130 by the solar panel 11. In the night, the LED can be lit up by just pressing the press-button switch 12. By the time, with the alternate refraction of the refracting grooves 150 and 151 of the light diffusion tube 15, the conical reflecting surface 160 of the reflecting base 16 and the reflecting surface 135 of the lower shell 13, the light of the LEDs can be refracted to diffuse effectively. In addition, the solar lamp 1 of the invention can be installed in any sort of lamp base, such as a courtyard lamp, an outdoor lamp or others exposed in sunlight.

While the preferred embodiment of the invention has been described above, it will be recognized and understood that various modifications may be made therein and the appended claims are intended to cover all such modifications that may fall within the spirit and scope of the invention.

What is claimed is:

1. A solar lamp comprising:
a supporting board loaded with a solar panel;
a lower shell fixed under said supporting board and provided with a battery and a circuit board;
at least one LED board threadably engaged with said lower shell;
a light diffusion tube wrapped around said at least one LED board and provided with plural refracting grooves formed closely spaced apart on its wall; and
a reflecting base installed at a bottom of said light diffusion tube and provided with an adjustment rod.

2. A solar lamp as claimed in claim 1, wherein said supporting board is provided with a press-button switch set aside and plural positioning bars formed at its bottom.

3. A solar lamp as claimed in claim 1, wherein said lower shell is provided with a switch base and a switch located aside, a through hole formed at a center of said lower shell, and plural threaded holes formed inside said lower shell.

4. A solar lamp as claimed in claim 1, wherein said lower shell is provided with a reflecting layer formed on its bottom surface.

5. A solar lamp as claimed in claim 1, wherein said at least one LED board is provided with a through hole and plural screw holes.

6. A solar lamp as claimed in claim 1, wherein said light diffusion tube is provided with straight refracting grooves formed closely spaced apart on its inner wall, spiral refracting grooves formed on its outer wall, and plural threaded holes formed around its upper inner circumference.

7. A solar lamp as claimed in claim 1, wherein said reflecting base is provided with a reflecting surface and a threaded portion formed at two ends of said adjustment rod respectively to engage with nuts to adjust a height of said reflecting base.
